(19) United States
(12) Patent Application Publication
(10) Pub. No.: US 2005/0202152 A1
(43) Pub. Date: Sep. 15, 2005

(54) Method for the industrial production of ambient stable, packed pasta

(76) Inventor: Katja Fichtenau, Heilbronn (DE)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(21) Appl. No.: 10/522,493

(22) PCT Filed: Jul. 9, 2003
(86) PCT No.: PCT/EP03/07407

§ 371 Date: Jan. 26, 2005

(30) Foreign Application Priority Data
Jul. 30, 2002 (DE) 10234656.9

(51) Int. Cl. A23L 1/168; A23L 1/172

(52) U.S. Cl. 426/618

(57) ABSTRACT

This invention relates to a method for the industrial production of pasta comprising 35-70% durum semolina, 0.2-1.0% alginate and 25-60% water. The ingredients are mixed and shaped into pieces or strands and cooked by contacting the pieces with hot wate or steam, whereafter the pieces are treated with a calcium chloride solution and placed in a containe in which they are sterilized.

This invention relates to a method for the industrial production of packed, ambient stable pasta, in particular products like spaetzle, gnocci, macaroni, spaghetti etcetera.

For reasons of convenience, there is a need for preserved, ambient-stable, packed pasta products, such as spaetzle, gnocci, macaroni, spaghetti, tagliatelle, lasagna, linguini, elbows, shells, penne, fettucine, fusilli and others.

Spaetzles are a type of pasta, in particular from the Swabian-Alemannic area, and in this area are one of the typical dishes. However, they are enjoying more and more popularity in other areas as well. In former times, their irregular, small-piece shape was due to the scraping of the dough from a wooden board directly into the boiling water, and today is usually achieved in the private kitchen by forcing the dough through a coarse colander. A housewife had to be skilled at taking out the dough pieces floating in the boiling water in due time using a skimming ladle, toss them in water having a moderate temperature and store them loosely so that although the finished spaetzles are doughy they do not stick together but remain separate.

In the industrial production of spaetzles which are not intended for immediate consumption it is also necessary to ensure durability in a suitable way. This may be done by drying. However, if an instant product shall be obtained which is sold in cans or other containers, this will require a concluding sterilization step connected with another heat treatment adding to the tendency of the spaetzles to stick together. Spaetzles made of classical spaetzle dough, i.e. flour, eggs and water, and subjected to a sterilization step resulted in a product unacceptable as regards appearance, texture and organoleptic properties.

Pasta products such as gnocci, macaroni, spaghetti, tagliatelle, lasagna, linguini, elbows, shells, penne, fettucine, or fusilli are well known in the art of italian cooking, and ways of preparation for fresh use can be found in many italian cook books.

Similar problems as for spaetzle exist for preparing such other ambient stable pasta products, such as e.g. macaroni, spaghetti and gnocci: a sterilisation step will often lead to the individual particles sticking together, which is undesired. This is a reason why many current convenience pasta products, such as for snack application, are preserved by drying. This, however, introduces the need for rehydration of the products prior to consumption.

Therefore, it was the object of the present invention to provide a method of producing packed, ambient stable pasta products, such as spaetzles, gnocci, macaroni, spaghetti, tagliatelle, lasagna, linguini, elbows, shells, penne, fettucine, fusilli etcetera, which are as much as possible (e.g. except for a packaging) equivalent to homemade pasta products, and which products are not preserved by drying (e.g. below a moisture content of 15 or 20%).

The laid-open Japanese patent application JP-A-06/209730 discloses a method of producing raw pasta stable in storage in a moist condition, which may be boiled for some seconds for the purpose of sterilization and are made of a wheat flour dough with or without the addition of starch, of alginic acid or alginate and of an alkaline substance. Due to the sterilization temperature of above 100° C. to be applied in this case the pasta shall adopt the desired elasticity and softness. A calcium-containing alkaline substance shall be avoided since it would react with the alginate, which shall lead to poorer results. The alginate is obviously used in this method to prevent softening of the pasta and providing them with strength, the alkaline agent seems to be used for taste reasons.

Chinese patent application CN1269144A discloses a method of producing wet noodles kept fresh and consisting of a dough made of wheat flour, starch, whole egg powder, glutenil powder, salt, sodium bicarbonate and sodium alginate, an agent which prevents sticking, such as liquid paraffin, being added after cooking and before sterilizing the noodles. The cooked noodles may then be sterilized, e.g. using steam for 25-45 minutes.

U.S. Pat. No. 5,211,977 discloses a process for preparing flavoured pasta which is dried for preservation. The flavoured pasta is prepared by making a dough consisting of a ground starchy product, starch, an emulsifier, a gelling agent, a flavouring composition and water. The pasta is then shaped by extrusion cooking, treated with a calcium chloride solution and dried.

Most of these and other known methods use wheat flour with or without the addition of starch. Although durum semolina has already been used for the production of pasta such as spaetzles, gnocci or the italian-type macaroni or spaghetti etc. as well, the replacement of wheat flour by durum semolina does not suffice to solve the problem as set.

It has now been found that the problem according to the invention can be solved (at least in part) by a process for the industrial production of packed, ambient stable pasta, which process comprises the steps of preparing a dough comprising (wt %):
a) 35-70% durum semolina,
b) 0.2-1.0% alginate,
c) 25-60% water,
d) optionally salt or other seasoning or flavoring agents, said dough is subsequently shaped into pieces or strands, and cooked by contacting the pieces or strands with hot water or steam, whereafter the pieces or strands are treated with a calcium chloride solution and placed in a container in which they are sterilized.

In the above, by using durum semolina instead of at least part of the wheat flour (e.g. replacing at least 50% of the flour for semolina), additionally adding a small amount of alginic acid or alginate to the dough and finally treating the cooked dough pieces with a calcium chloride solution. Pasta particles like gnocci, spaetzles, macaroni, spaghetti etc. produced in this way can be introduced in a wet condition into a container where they are sterilized, a product being obtained which in spite of a good doughiness does not lump together but is retained as separate pieces.

Preferably, in the process according to the invention a homogeneous dough is made essentially of 35-70% durum semolina, 0.2-1.0% alginate, 25-60% water and, where appropriate the balance being salt or other seasoning or flavoring agents, said dough being introduced in pieces or as a strand into hot water where it is boiled. Thereafter, the pieces are treated with a calcium chloride solution and finally placed in a container where they are sterilized.

The durum semolina to be used according to the invention is understood to mean a grainy milling product of durum wheat having a particle size range of generally 0.15-0.85 mm. A minimum particle size of 0.125 mm should be aimed at. Apart from the particle size, durum semolina differs from wheat flour by a higher dietary fiber content which is at the order of 5% by weight. Durum semolina is a known commercial product and the designation durum wheat serves as a distinction from what is called soft wheat.

The alginate used is generally sodium alginate which is a known thickening agent.

Common salt is predominantly used as the seasoning agent. Whole egg or eggwhite can also be added to the dough. However, egg white, e.g. chicken egg white, is not needed as a structural substance, the alginate in combination with the calcium ions take over the role of the chicken egg white in the classical spaetzle dough.

Cheese or a cheese aroma can be used as a flavoring agent.

By means of the method according to the invention it is possible to offer a wet product which can be prepared quickly and simply and, since it can be sterilized owing to the present invention, has a good durability and can also be stored without cooling, e.g. as a wet can.

The method according to the invention can be carried out e.g. such that initially the components durum semolina, sodium alginate and common salt are premixed in a dry state, the dry mixture is then formed into a paste using water, the wet dough is kneaded after a short rest of 10 minutes, for example, wherein further amounts of semolina may be added, then the dough is shaped into e.g. pieces or strands which are cooked in boiling water for 0.5 to 3 minutes, e.g. for 1 minute, then cooled and treated in a 0.2-3%, e.g. 1%, CaCl₂ solution for 0.2-2 hours, e.g. for 30 minutes, thereafter washed by spraying them with water or immersing them in water and finally placed in containers, e.g. cans, where they are sterilized. The sterilization may be carried out at a temperature of 100-130° C. for 10-60 minutes. For example, the moist pasta products can be heated to about 120° C. at an excess pressure of 1.2 bar for 10 to 15 minutes and kept at this temperature and under the same pressure for 45 minutes, which may be followed by a cooling phase.

The rest phase after the wet dough preparation is recommendable and serves for improving the texture. In order to improve the texture it is likewise recommendable to add another partial durum semolina quantity during the kneading phase so as to create an additional swelling capacity and a bumpy surface of the pasta particles.

A preferred method according to the invention uses 35-70% by weight, preferably 55-60% by weight, durum semolina with 25-60% by weight, preferably 40-45% by weight, water. The alginate amount is generally 0.5-1.0, preferably 0.3-0.8% by weight, all percentages being based on the total dough amount.

In the process according to the invention the dough pieces are preferably sterilized in an open or closed can. The pasta particles, strands or pieces in the above disclosed process can be e.g. in the shape of spaetzle, gnocci, macaroni, spaghetti, tagliatelle, lasagna, linguini, elbows, shells, penne, fettucine, or fusilli. The packaging is preferably in a plastic container or a can.

### EXAMPLE 1

Ingredients:
a) 580 g durum semolina, 0.2-0.5 mm
b) 6 g alginate
c) 16 g salt
d) 500 g water
e) 100 g durum semolina 0.2-0.5 mm.

Ingredients a, b and c are stirred homogeneously in a bowl. Thereafter, the water (d) is added and the mixture is continued to be stirred for about 10 seconds until the water has been distributed homogeneously and the semolina is fully wetted with water. The resulting mixture is allowed to rest for 10 minutes. Then, the additional amount of semolina (e) is added by stirring within about 5 seconds, and the dough is allowed to rest for approximately 5 more minutes.

The dough prepared in this way is forced into boiling water using a potato press (hole diameter 2.5 mm) and, following boiling up, is allowed to cook for about 1 more minute. The cooked spaetzles are removed using a skimming ladle and stored in 1% CaCl₂ solution for 1 hour. Then, in order to neutralize the surface which has a slightly bitter taste, they are stored in washing water for 50 minutes. Thereafter, the spaetzles are allowed to drip and placed in a closed container where they are sterilized at 120° C. for 45 minutes.

It turns out that the dough can be pressed well. The spaetzle strands separate when both forced through a press and cooked in water. The spaetzle surface is bumpy and smooth, the texture is firm and grips well, and these properties are preserved even after the sterilization.

### COMPARATIVE EXAMPLE 1

Example 1 was repeated, the only difference being that wheat flour was used in place of durum semolina.

It turns out that the dough can only be forced through the press with difficulty, the resulting spaetzle strands strongly stick together and although the spaetzles are al dente, they are unpleasantly doughy.

### COMPARATIVE EXAMPLE 2

Example 1 was repeated, the only difference being that 6 g chicken egg white was used in place of 6 g alginate and that the treatment with 1% CaCl₂ solution and the subsequent storage in washing water were dispensed with. The spaetzles removed from the boiling water were only placed in cold water for 2 minutes for the purpose of cooling.

It turns out that although the dough can easily be forced through the press the resulting spaetzle strands greatly stick together and can only be separated in the water when a mechanical force is exerted. The spaetzles have a porous appearance, are soft and have a very sticky surface.

### COMPARATIVE EXAMPLE 3

Comparative example 2 was repeated, the exception being that the addition of chicken egg white was dispensed with without replacement.

It turns out that although the dough can be pressed easily, the resulting spaetzle strands greatly stick together and can only be separated in water when a mechanical force is exerted. The spaetzles have a porous and rather glassy appearance, they are soft and have a very sticky surface.

The invention further relates to packaged, ambient stable, sterilised pasta particles having a composition comprising
a) 35-70% durum semolina,
b) 0.2-1.0% alginate,
c) 25-60% water.

Such packaged ambient stable pasta particles may be spaetzle, gnocci, macaroni, spaghetti, tagliatelle, lasagna, linguini, elbows, shells, penne, fettucine, or fusilli, e.g. packed in cans or plastic containers or pouches.

1. Process for the industrial production of packed, ambient stable pasta, which process comprises the steps of preparing a dough comprising (wt %):
a) 35-70% durum semolina,
b) 0.2-1.0% alginate,
c) 25-60% water,
d) optionally salt or other seasoning or flavoring agents, said dough is subsequently shaped into pieces or strands, and cooked by contacting the pieces or strands with hot water or steam, whereafter the pieces or strands are treated with a calcium chloride solution and placed in a container in which they are sterilized.

2. Process according to claim 1, wherein the dough consists essentially of:
35-70% by weight durum semolina,
25-60% by weight water,
0.2-1.0% by weight alginate,
the balance being salt or other seasoning or flavoring agents.

3. Process according to claim 1, wherein the dough pieces or strands are cooked in boiling water for 0.5 to 3 minutes.

4. Process according to claim 1, wherein the cooked dough pieces or strands are treated with a 0.2-3% CaCl₂ solution for 0.2-2 hours.

5. Process according to claim 1-4, wherein the dough pieces are sprayed with water or stored in water.

6. Process according to claim 1, wherein the dough pieces are sterilized in an open or closed can.

7. Process according to claim 1, wherein the pieces or strands are in the shape of spaetzle, gnocci, macaroni, spaghetti, tagliatelle, lasagna, linguini, elbows, shells, penne, fettucine, or fusilli.

8. Process according to claim 1, wherein packaging is in a plastic container or a can.

9. Packaged, ambient stable, sterilised pasta particles having a composition comprising
(a) 35-70% durum semolina,
(b) 0.2-1.0% alginate,
(c) 25-60% water.

10. Packaged ambient stable pasta particles according to claim 9, wherein the pasta particles are spaetzle, gnocci, macaroni, spaghetti, tagliatelle, lasagna, linguini, elbows, shells, penne, fettucine, or fusilli.
